(19) United States
(12) Patent Application Publication
(10) Pub. No.: US 2002/0060182 A1
(43) Pub. Date: May 23, 2002

(54) Edge-type filter

(76) Inventor: Daniel J. O'Connell, Meriden, CT (US)

Correspondence Address: Scott D. Wofsy, Esq., CUMMINGS & LOCKWOOD, 700 State Street, P.O. Box 1960, New Haven, CT, 06509-1960, US

(21) Appl. No.: 09/954,233

(22) Filed: Sep. 17, 2001

Related U.S. Application Data
(60) Provisional application No. 60/249,856, filed on Nov. 17, 2000.

(51) Int. Cl. B01D 29/46

(52) U.S. Cl. 210/443; 210/492; 210/497.01; 210/498

(57) ABSTRACT

An edge-type filter cartridge is disclosed which includes a housing and a plurality of filter disc assemblies coaxially stacked within an interior cavity of the housing for conditioning fluid passing therethrough. The filter disc assemblies include an upper filter disc, a lower filter disc, an outer spacer disc and inner spacer disc, the filter discs having a body portion and defining at least one filtration aperture for filtering fluid passing therethrough. The outer spacer discs are disposed between the upper and lower filter discs and defines a gap therebetween. It is further disclosed that the filtration apertures can be formed by a laser cutting technique.

### CROSS-REFERENCE TO RELATED APPLICATIONS

This application claims priority to U.S. Provisional Patent Application No. 60/249,856, filed Nov. 17, 2000, which is herein incorporated by reference in its entirety.

### BACKGROUND OF THE INVENTION

1. Field of the Invention

The subject application relates to a filtration apparatus and more particularly, to an edge-type disc filter having filtration gaps formed by a laser.

2. Background of the Related Art

Edge-type filters or metal disc filters are well known in the art and have been in use for decades. These filters generally include a plurality of stacked metal filtration discs disposed within a filter housing and supported about a central core. Edge-type filters are typically employed to filter hot gases, chemicals and fluids such as resins, greases, inks, tar, waxes, soap, oils and fuels.

The AutoKlean® filter manufactured and sold by Cuno Incorporated of Meriden, Connecticut, the assignee of the subject application, is an example of a prior art edge-type filter. The AutoKlean® filter includes a plurality of filter discs and spacer discs stacked in an alternating arrangement on a central shaft within a housing. Each filter disc has an inside diameter and an outside diameter that forms a circumferential ring portion which is connected to a central mounting portion by four radial webs. Like the filter discs, each spacer disc includes a mounting portion and four radial webs, but it does not include a circumferential ring portion.

In this type of filter configuration, by disposing a spacer disc between adjacent filter discs, a filtration gap is established between the ring portions of the filter discs. Fluid which is received within the housing flows from its outer periphery, radially inward through the gap or space established between the filter discs by the spacer disc. Particles which are suspended within the fluid and are larger than the established gap are lodged along the edges of and between the adjacent filter discs and are thereby filtered from the fluid. The filtered fluid then flows into passages defined between the radial webs and proceeds axially through the center of the filter until it is discharged from the housing.

This type of filter typically includes a cleaning mechanism in the form of a plurality of blades for removing the particles which were lodged along the edges of and between the stacked filter discs. The cleaning blades are mounted on a stationary rod which extends through the filter housing, parallel to the central axis. The blades are dimensioned and configured to project radially into the gap or space established between the adjacent filter discs without contacting the spacer disc disposed therein. Periodic cleaning is achieved by rotating a handle located external to the housing and operatively connected to the central shaft. Rotation of the handle causes the discs to rotate within the housing and, as a result, the stationary cleaning blades “comb” the particles lodged between the discs, restoring full flow conditions.

In another prior art edge-type filter, the Super Auto-Klean® filter, also manufactured and sold by Cuno Incorporated, a second filtration gap is defined by a difference in diameters of coaxially arranged discs. More specifically, the disc stack is formed by alternating major and minor filter discs on a central shaft. Both the major discs and the minor discs have a circumferential ring portion which is defined by inside and outside diameters. As in the Auto-Klean® filter, the thickness of the minor discs establish a filter gap between adjacent major discs. However, in addition to this filtration gap, a second filtration gap is formed between the outside diameter of the minor disc and the inside diameter of the major disc, or by the radial spacing between the ring portions of the minor and major discs. Fluid which has first been filtered by the gap established between adjacent major discs flows radially inward between the major discs until it reaches the inside diameter thereof. Then, the fluid flows axially through the second gap established between the outside diameter of the minor disc and the inside diameter of the major disc, thereby receiving a second level of gap filtration.

In fluid filtration, it is often important to be able to certify the accuracy of the filtration apparatus or provide an absolute rating for the filter. Many industrial applications require a specific level of filtration that must be controlled within a narrow range of tolerances. The filtration removal rating for an edge-type filter, such as Cuno's AutoKlean® filter, is a function of the fabricating tolerances associated with the discs. For example, the filtration removal accuracy of these filters is directly related to the accuracy associated with the filtration gap established between adjacent discs. This gap size is largely dependant on the tolerances associated with the thickness of the spacer disc disposed between the filter discs and the flatness of all the discs in the stack.

Like the AutoKlean® filter, the rating for the Super Auto-Klean® filter is a function of the tolerance associated with the thickness of the minor spacer discs and the flatness of all of the discs in the stack. However, the second filtration gap is a function of the fabricating tolerances associated with the ring portions of the major and minor filter discs. More specifically, the second filtration gap is a function of both the circularity of the discs and their concentricity.

The discs used in edge-type filters are normally manufactured from sheet steel, such as CR304 or 316 stainless and typically have a design thickness which ranges from 0.003″ to 0.015″. Sheet steel of this thickness can normally be rolled within an accuracy of about 0.001″ to 0.008″ depending on the type of steel selected and the rolling process used. All of these discs traditionally have been fabricated by a metal stamping process. The metal stamping process can distort the flatness of the discs, and even though the discs are normally rolled subsequent to the stamping, the initial flatness of the stock material as received from the plate manufacturer cannot be restored.

When determining the filtration removal rating of a filter, all of the fabrication and dimensional tolerances are cumulative. In traditional edge-type filters, the combined tolerance is such that an absolute rating cannot be assigned to these filter and they generally have removal ratings limited to about a 0.003″ particle size.

There is a need, therefore, for a new edge-type filter in which tighter dimensional control of the filter components and a revised filter configuration provides for more accuracy in the filtration, allows for smaller particles to be removed from the fluid, and allows an absolute removal rating to be assigned to the filter.

### SUMMARY OF THE INVENTION

The subject application is directed to a new and useful filter cartridge, and more particularly, to an edge-type disc filter which includes a housing and a filter disc assembly disposed within the housing. The housing defines a central axis and an interior cavity and has an inlet portion and an outlet portion, which allow the filtrate to be received into and discharged from the interior cavity. The filter disc assembly, which is disposed within the interior cavity of the housing, conditions the media, namely fluids, hot gases, or chemicals which pass therethrough.

The filter disc assembly has three coaxially stacked discs including; an upper filter disc, a lower filter disc and an outer spacer disc. The upper filter disc has a body portion and defines at least one filtration aperture for filtering fluid passing therethrough. Similarly, the lower filter disc has a body portion and defines at least one filtration aperture for filtering fluid passing therethrough. In the installed configuration, the filtration apertures of the upper and lower discs are axially aligned.

The outer spacer disc also includes a body portion. However, the body portion is positioned radially outward of the filtration apertures that are formed in the upper and the lower filter discs. The outer spacer disc is disposed or stacked between the upper and lower filter discs, defining a gap or space between the body portion of the filter discs, along their outer circumference. The filter disc assembly has a central core which is in fluid communication with the outlet portion of the housing.

It is envisioned that the filter cartridge further includes an upper and a lower inner spacer disc, where the upper inner spacer disc is positioned adjacent to the upper filter disc and the lower inner space disc is positioned adjacent to the lower filter disc. Each inner spacer disc includes a body portion which is dimensioned and configured to be positioned radially inward of the filtration apertures of the upper and lower filter discs. This configuration allows fluid to communicate between the inlet portion of the housing and the filtration apertures of the upper and lower filter disc.

In operation, fluid enters the interior cavity of the housing along the outer periphery through the inlet portion. Then the fluid proceeds in a radially inward direction through the filtration apertures formed in each of the upper and lower filter discs and is conditioned thereby.

Next, the filtered fluid exits the interior cavity through the central core of the filter assembly and the outlet portion of the housing.

In this embodiment, it is preferred that the filter cartridge also include a mounting element which extends through the interior cavity of the housing and parallel to the central axis.

The mounting element is dimensioned and configured to engage the body portions of the upper and lower filter discs so as to secure the filter disc assembly within the interior cavity of the housing and maintain alignment of the filtration apertures. In one embodiment, the mounting element is a single elongated rod extending through the interior cavity of the housing and along the central axis. Alternatively, the mounting element can include two or more diametrically opposed elongated rods which extend through the interior cavity of the housing parallel to the central axis.

In a preferred embodiment, the filtration apertures that are defined in the upper and lower filter discs are formed by a laser cutting technique and have a minimum width of approximately 0.0004 inches which is controlled to a tolerance of +0.0005 inch. It is also envisioned that the body portions of the upper and lower filter discs and the outer and inner spacer discs can be formed by laser cutting and can be dimensionally fabricated to a tolerance of approximately + or −0.001 inches. It is envisioned that the upper and lower filter discs are manufactured from a material such as steel, 304, 316 stainless steel or brass.

In one embodiment, the apertures defined by the upper and lower filter discs are linear. Alternatively, the apertures defined by the upper and lower filter discs can be arcuate-shaped, w-shaped, or sinusoidal. Preferably, the apertures defined by the upper and lower filter discs are arranged in a single row around the circumference of the filter discs. Alternatively, multiple radially spaced apart rows of apertures can be formed in the filter discs.

The subject invention is also directed to an edge-type filter cartridge which includes a housing having an inlet portion, an outlet portion, and defining a central axis and an interior cavity. The edge-type filter cartridge further includes a plurality of filter disc assemblies coaxially stacked within the interior cavity of the housing for conditioning fluid passing therethrough. The plurality of filter disc assemblies have a central core in fluid communication with the outlet portion of the housing. Each filter disc assembly includes an upper filter disc, a lower filter disc, an outer spacer disc and inner spacer disc. The upper and lower spacer discs have a body portion and define at least one filtration aperture for filtering fluid passing therethrough. The outer spacer discs include a body portion which is located radially outward of the filtration apertures of the upper and the lower filter discs and are disposed between the upper and lower filter discs, defining a gap therebetween.

The gap allows the filtration apertures of the upper and lower filter discs to be in fluid communication with the central core of the filter disc assembly. The inner spacer disc is disposed between adjacent filter disc assemblies and includes a body portion that is positioned radially inward of the filtration apertures of the upper and lower filter discs. The inner spacer disc defines a pre-filtration gap between the filter disc assemblies. The pre-filtration gap allows fluid to communicate between the inlet portion of the housing and the filtration apertures of the upper and lower filter discs.

Similar to the previously described embodiments, the filter cartridge preferably further comprises a mounting element which extends through the interior cavity of the housing and parallel to the central axis and engages with the mounting portions of the upper and lower filter discs and the inner spacer disc. The mounting element secures the plurality of filter disc assemblies and the inner spacer discs the within the interior cavity of the housing and maintains alignment of the filtration apertures.

Similarly to previous embodiments, the filtration apertures that are defined each of the upper and lower filter discs can be formed by traditional mechanical cutting or laser cutting. The minimum width achievable with the laser cutting process is approximately 0.0004 inch. This width can be controlled to a tolerance of approximately +0.0005 inch. The use of laser cutting also permits the apertures to be formed in a variety of shapes , such as arcuate, w-shaped, or sinusoidal.

The subject application is also directed to a filter disc for use in an edge-type filter. The filter disc is fabricated from a metal or steel alloy, such as brass, stainless steel or CR304 or 316, and includes primarily a ring portion having opposed upper and lower faces and a mounting portion. At least one filtration aperture is formed in the ring portion by laser cutting and extends between the upper and lower faces. The filtration aperture filters fluid passing therethrough by preventing particles which are suspended in the fluid and are larger than the aperture size for passing. It is envisioned that the filter disc is manufactured from a material such as steel, 304 or 316 stainless steel or brass. The mounting portion enables the filter disc to be secured within a filter cartridge.

The subject invention is also directed to a method of fabricating a filter disc for use in an edge-type filter which includes the steps of providing a blank of steel sheet material having a selected thickness and laser cutting a circular filter disc from the blank steel sheet. The filter disc havs a ring portion with at least one filtration aperture formed therein and a mounting portion. Preferably, the method further includes the step of forming by laser cutting the at least one aperture defined in the ring portion of the circular filter disc and flattening the filter disc by mechanical rolling.

Those skilled in the art will readily appreciate that the disclosure of the subject application provides a novel edge-type filter configuration and method of manufacture for the individual discs used in the filter. The configuration disclosed herein is dimensioned and configured such that aperture filtration is provided subsequent to gap pre-filtration. In addition to providing a second zone of filtration, the aperture filtration can be more accurately controlled in that the accuracy of the aperture size is a function of the cutting process only and not the fabrication tolerance for the disc. The accuracy of the aperture size allows an absolute filtration removal rating to be achieved. The configuration disclosed herein also increases the flow rate available for the filtration process by enabling the number, shape and arrangement of the apertures to be increased as desired.

The method of manufacture disclosed herein, namely the use of a laser to form the apertures and the discs themselves, affords tighter dimensional control of apertures and the filter discs, thereby further increasing the accuracy of the filtration.

These and other unique features of the edge-type filter disclosed herein will become more readily apparent from the following description, the accompanying drawings and the appended claims.

### BRIEF DESCRIPTION OF THE DRAWINGS

So that those having ordinary skill in the art to which the present application appertains will more readily understand how to make and use the same, reference may be had to the drawings wherein:

FIG. 1 is a perspective view of a prior art edge-type filter illustrated in an installed condition and having a fluid supply conduit and a fluid discharge conduit associated therewith;

FIG. 2 is an partially exploded perspective view of the prior art edge-type filter of FIG. 1, illustrating a head portion in fluid communication with the supply and discharge conduits and a housing portion having a plurality of filter discs and spacer discs stacked on a central shaft;

FIG. 3 is a partially exploded perspective view of the prior art edge-type filter of FIGS. 1 and 2, illustrating two filter discs, two spacer discs, the central support shaft and two cleaning blades mounted on a second shaft;

FIG. 4 is a perspective view of the prior art edge-type filter of FIGS. 1, 2 and 3, illustrating the operation of the cleaning blades and the removal of particles from within the filtration gap created between the filter discs by the spacer disc;

FIG. 5 is a partially exploded perspective view of an edge-type filter disc assembly constructed in accordance with a preferred embodiment of the subject invention with parts separated for ease of illustration, illustrating a head portion, a housing portion and a plurality of filter disc assemblies and inner spacer discs mounted on four elongated rods which are attached to a base member.

FIG. 6 is a partially exploded perspective view of a filter disc assembly constructed in accordance with a preferred embodiment of the subject invention, wherein a plurality of filter discs, inner spacer discs and outer spacer discs are coaxially stacked on four mounting rods;

FIG. 7 is a partial cross-sectional view of an edge-type filter constructed in accordance with a preferred embodiment of the subject invention which illustrates the flow of fluid axially along the outer periphery of the filter housing, the radially through the filter disc assemblies and into the central core;

FIG. 7A is a partial cross-sectional view of the edge-type filter as shown in FIG. 7 in which the apertures formed in the filter discs have been cut at an angle with respect to the central axis;

FIG. 8 is a top plan view of a filter disc constructed in accordance with a preferred embodiment of the subject invention, wherein eight (8) arcuate laser cut apertures and four mounting holes are formed in the filter disc;

FIG. 9 is a top plan view of a filter disc constructed in accordance with a preferred embodiment of the subject invention, wherein a plurality of arcuate laser cut apertures and four mounting holes are formed in the ring portion of the filter disc, the apertures being positioned in two rows which are radially spaced apart;

FIG. 10 is a top plan view of a filter disc constructed in accordance with a preferred embodiment of the subject invention, wherein eight (8) w-shaped laser cut apertures and four mounting holes are formed in the filter disc; and

FIG. 11 is a partial cross-sectional view of an edge-type filter constructed in accordance with a preferred embodiment of the subject invention which illustrates the flow of fluid axially along the outer periphery of the filter housing, through the filter disc assemblies and into the central core.

These and other features of the subject invention will become more readily apparent to those having ordinary skill in the art form the following detailed description of the preferred embodiments.

### DETAILED DESCRIPTION OF PREFERRED EMBODIMENTS

The present invention overcomes several of the problems associated with prior art edge-type filters used to filter hot gases, chemicals and fluids such as resins, greases, inks, tar, waxes, soap, oils and fuels to name a few. The advantages, and other features of the edge-type filter disclosed herein, will become more readily apparent to those having ordinary skill in the art from the following detailed description of the preferred embodiments taken in conjunction with the drawings which set forth representative embodiments of the present invention.

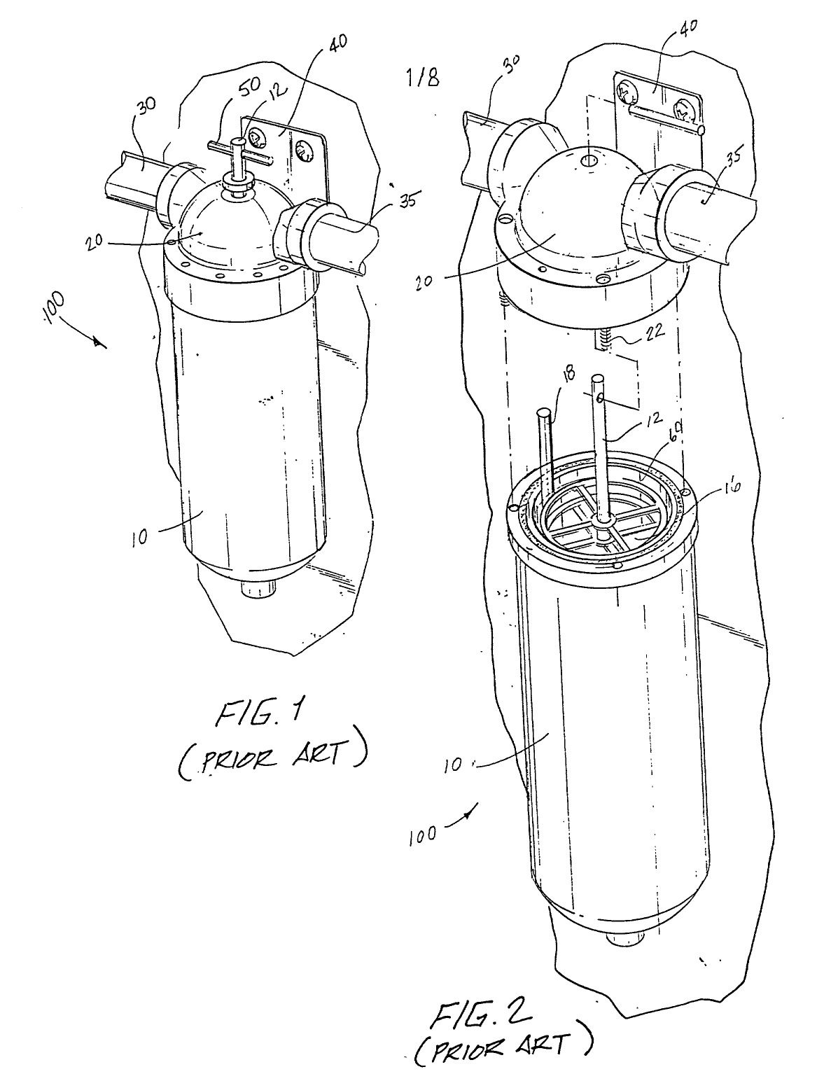

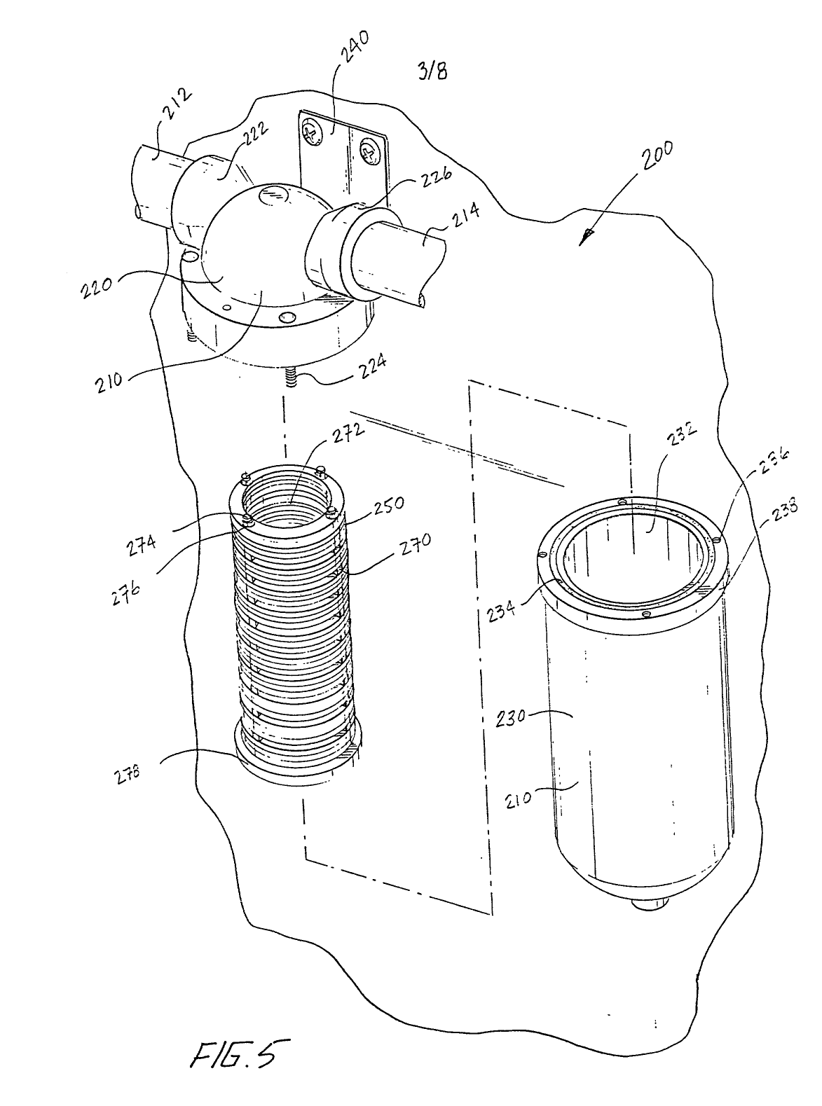

Referring now to the drawings wherein like reference numerals identify similar structural elements of the subject invention, there is illustrated in FIG. 1 a prior art edge-type filter designated generally by reference numeral 100. Filter 100 includes a housing portion 10 and a head member 20 which define an interior cavity and a central axis for the filter. A plurality of filter discs 60 and spacer discs 70 (FIG. 3) are stacked in an alternating arrangement on central shaft 12 within the interior cavity of the housing. Support bracket 40 is connected to head member 20 and allows filter 100 to be mounted to support structure.

In operation, fluid is supplied to filter 100 by inlet conduit 30 which is in fluid communication with head member 20 and directed into the interior cavity along the outer periphery of housing 10. Next the fluid proceeds in a radially inward direction through the stacked discs (not shown) and is conditioned thereby. The conditioning process will be discussed in more detail hereinbelow. Subsequent to the conditioning, the filtered fluid is discharged from filter 100 through head member 20 and outlet conduit 35.

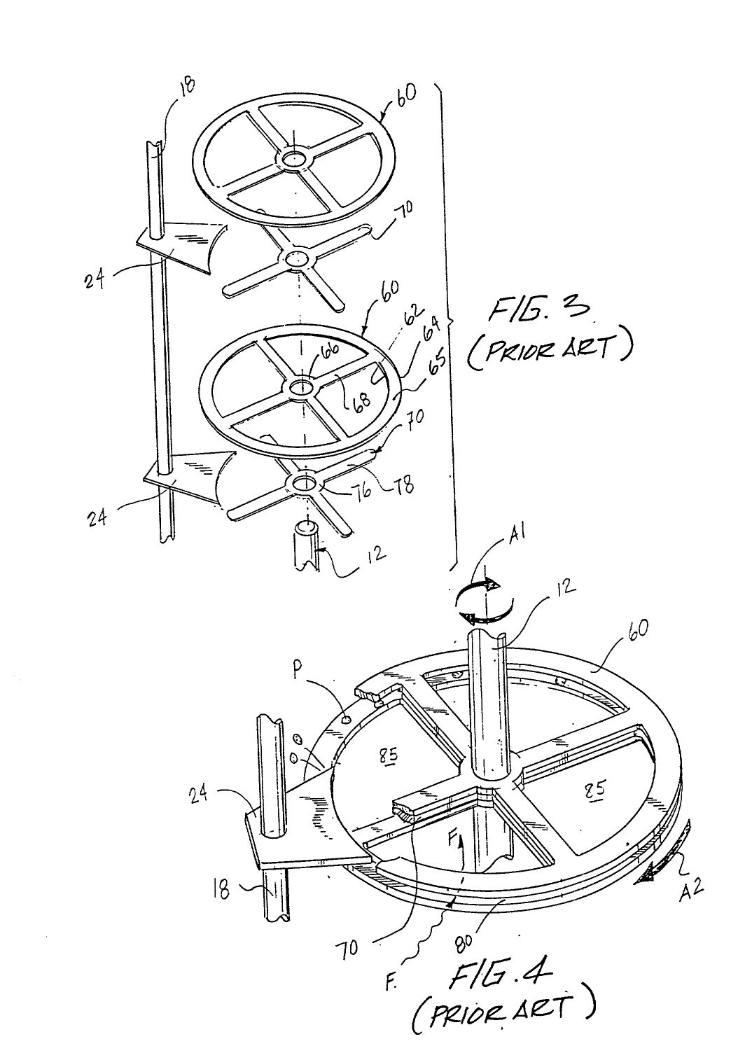

Referring now to FIG. 2 which illustrates a partially exploded view of filter 100 in which mechanical fasteners 22 have been disengaged from housing portion 10 and handle portion 50 has been removed from central mounting shaft 12, allowing the housing portion 10 to be disconnected from the head member 20. Central mounting shaft 12 is shown disposed within the interior cavity 16 of housing portion 10 and has a plurality of filter discs 14 and spacer discs 16 (FIG. 3) stacked thereon.

Referring now to FIGS. 3 and 4 which illustrates an exploded view of the stacked discs 60 and 70. As shown therein, filter discs 60 and spacer discs 70 are stacked in alternating relationship. Each filter disc 60 has an inside diameter 62 and an outside diameter 64 that forms a circumferential ring portion 65. The circumferential ring portion 65 is connected to a central mounting portion 66 by four radial webs 68. Like the filter discs 60, each spacer disc 70 includes a mounting portion 76 and four radial webs 78, but they do not include a circumferential ring portion.

Referring now to FIG. 4, in this type of filter configuration, by disposing a spacer disc 70 between adjacent filter discs 60, a filtration gap 80 is established between the ring portions 65 of the filter discs 60. Fluid which is received within the housing flows from its outer periphery in a radially inward direction, as indicated by directional arrow F, through filtration gap 80 or the space established between adjacent filter discs 60 by spacer disc 70. Particles P which are suspended within the fluid and are larger than the established gap 80 are lodged along the edges of and between the adjacent filter discs 60 and are thereby removed or filtered from the fluid. The filtered fluid then flows into passages 85 defined between the radial webs 68 and 78 of the filter discs 60 and the spacer discs 70 and proceeds axially through the center of the filter until it is discharged from housing 20 (not shown).

Cleaning blades 24 are mounted on a stationary rod 18 that extends through filter housing 20, parallel to the central axis. The blades 24 remove particles P which were lodged along the edges of and between the stacked filter discs 60. As shown herein, the blades 24 are dimensioned and configured to project radially into the gap 80 or the space established between the adjacent filter discs 60 without contacting the spacer disc 70 disposed therein. It should be noted that the spacer discs 60 are dimensioned such that the webs 78 are positioned radially inward of the filter disc's circumferential ring portion 65.

Cleaning is achieved by rotating handle 50 (FIG. 1) which is operatively connected to central shaft 12. Rotation of the handle 50 imparts a rotation on discs 60 and 70 within the housing 20 and, as a result, the stationary cleaning blades 24 “comb” the particles P lodged between the filter discs 60, restoring full flow conditions.

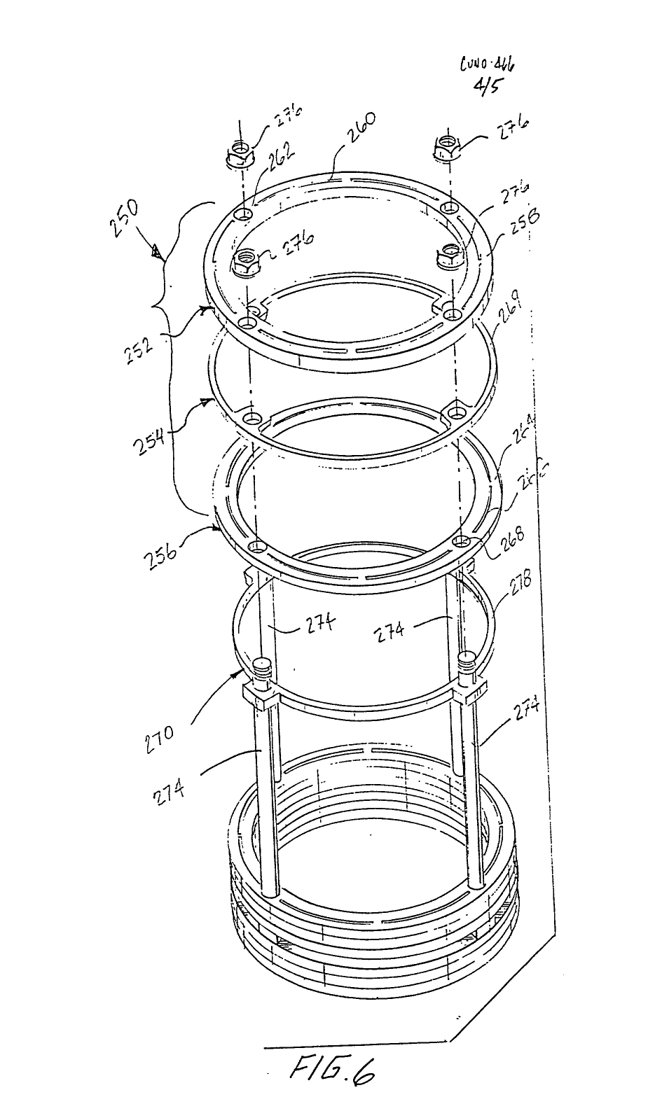

Referring now to FIG. 5 which illustrates an edge-type filter constructed in accordance with a preferred embodiment of the subject invention an designated generally by reference numeral 200. Filter 200 includes, inter alia, four main components: a housing 210, a plurality of filter disc assemblies 250, a plurality of inner spacer discs 270, and an L-shaped support bracket 240. Housing 210 is a two piece construction having an upper head portion 220 and a lower body portion 230 that define an interior cavity 232. An inlet portion 222 is associated with the upper head portion 220 and allows fluid to be received into the interior cavity 232 of the housing 210. An outlet portion 226 is also associated with the upper head portion 220 and allows conditioned fluid to be discharged from the interior cavity 232.

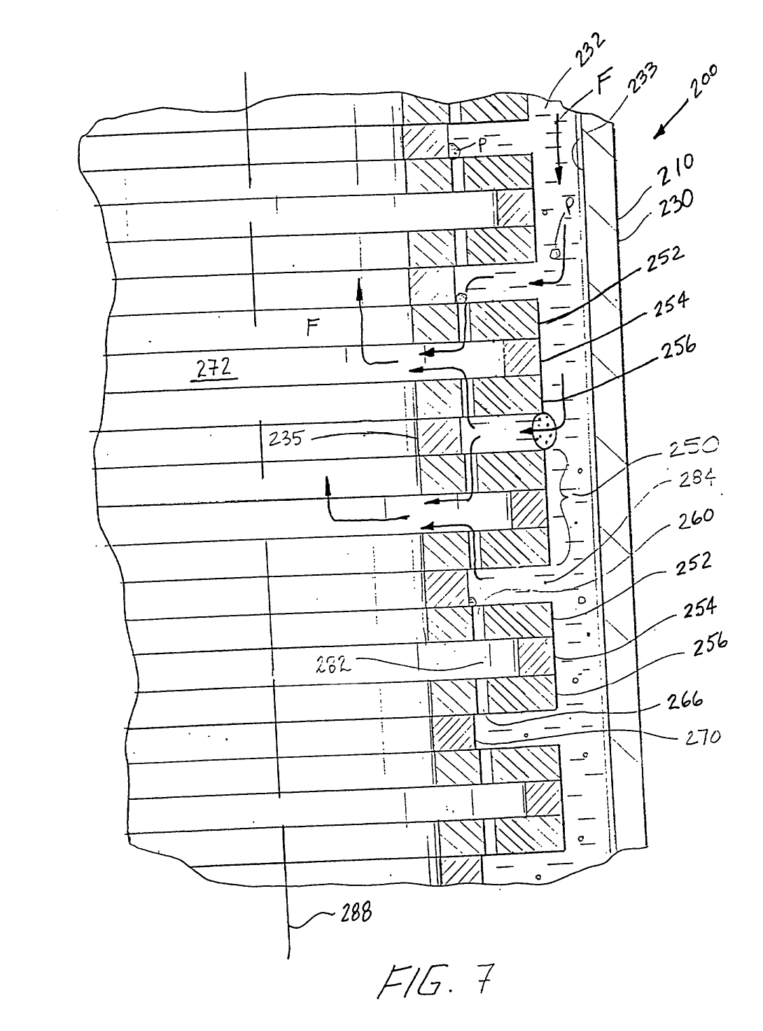

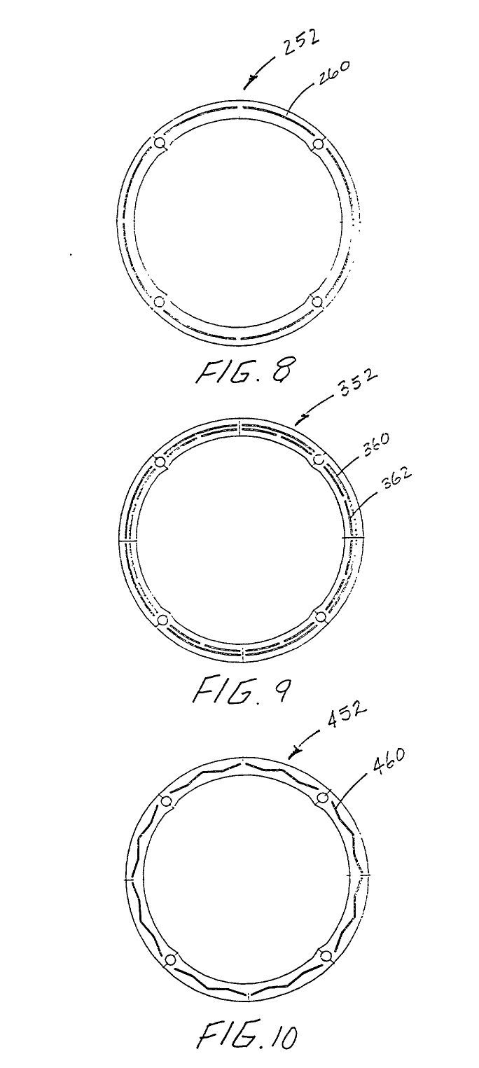

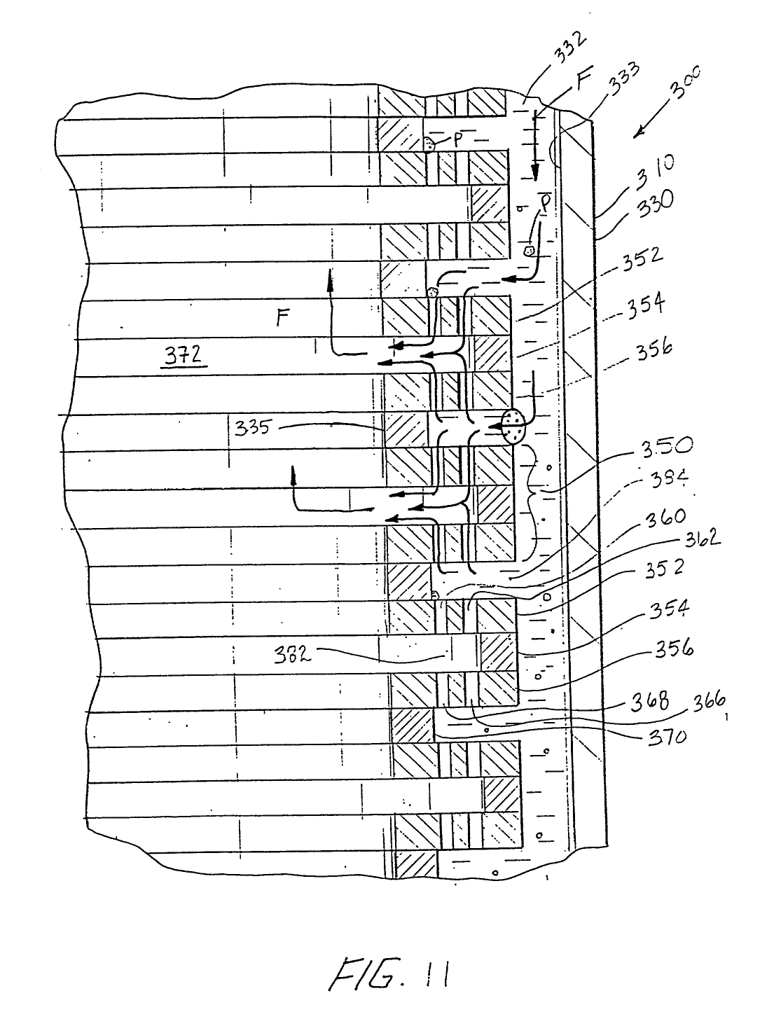

The plurality of filter disc assemblies 250 and inner spacer discs 270 are coaxially stacked in an alternating arrangement within the interior cavity 232 and function to condition the fluid passing therethorugh. The stacked discs 250 and 270 are secured together by four mounting rods 274 which extending through the interior cavity 232 of the housing 210 and parallel to the central axis. The mounting rods 274 are attached to a circular base 278 and engage with the filter disc assemblies 250 and the inner spacer discs 270 so as to maintain their radial alignment and create a central core 272 which is in fluid communication with the outlet portion 226 of housing 210. Locking nuts 276 are threadably engaged with the upper portion of mounting rods 274 and prevent the stacked discs 250 and 270 from sliding axially off mounting rods 274. Details of the structure and operation of the stacked discs 250 and 270 will be provided in conjunction with the detailed description of FIGS. 6 and 10 respectively.

With continuing reference to FIG. 5, as noted above, the method of maintaining the radial alignment of the discs shown herein includes four elongated rods 276 positioned offset from the central axis of the filter 200. However, in an alternate embodiment, two diametrically opposed rods are used to secure and align the disc stack. Alternatively, a single rod or shaft which is aligned with the central axis can be used and the filter disc assemblies 230 and inner spacer discs 235 can be dimension and configured so as to engage with the central rod. Still yet further, the housing 210 can be configured to have an integrated mounting or positioning element associated with the wall of the interior cavity 232 so that the elongated rods 276 can be eliminated.

Mechanical fasteners 224 are associated with head portion 220 and engage with corresponding threaded holes 236 which have been drilled and tapped in upper flange 238 of the lower body portion 230. The mechanical fasteners secure the body portion 230 in sealing engagement with the head portion 220. An elastomeric gasket 234 is disposed in a groove formed in the upper flange 238 to facilitate the seal between the upper head portion 220 and the body portion 230.

Support bracket 240 is attached to head portion 210 and mounts filter 200 in the installed position. In this position, inlet portion 222 is fluidly connected to supply conduit 212 and discharge portion 226 is connected to outlet conduit 214.

Referring now to FIG. 6 which illustrates the stacked arrangement of filter disc assemblies 250 and inner spacer discs 270 in accordance with a preferred embodiment of the subject invention. The plurality of filter disc assemblies 250 include an upper filter disc 252, a lower filter disc 256, and an outer spacer disc 254. The discs are arranged such that the outer spacer disc 254 is disposed between the upper and lower filter discs 252 and 256. In the embodiment shown herein, an inner spacer disc 270 is disposed between adjacent filter disc assemblies 250.

The upper spacer disc 252 has a ring or body portion 258 which has eight arcuate apertures 260 and four mounting holes 262 formed therein. The apertures 260 are provided as a means for filtering fluid passing therethrough and are dimensioned and configured according to the desired filtration characteristics for filter 200. One skilled in the art would readily appreciate that the number, arrangement and shape of the filtration apertures 260 can vary and be adjusted to suit the desired filtration flow rate and rating.

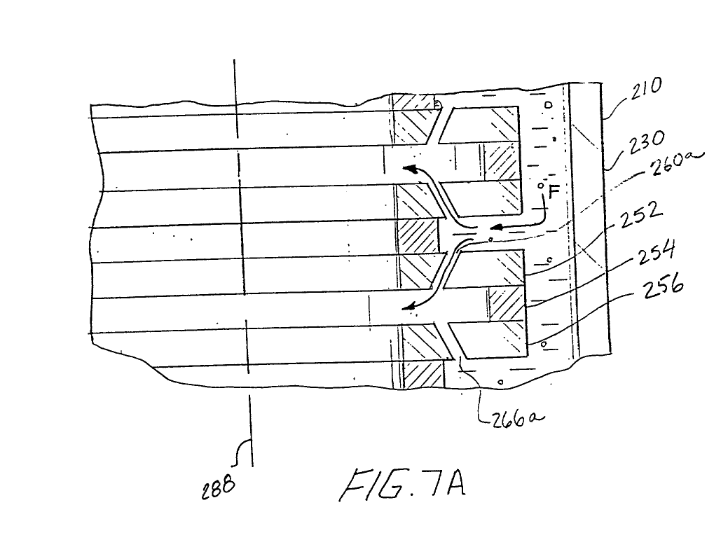

The lower filter disc also has a body portion 264 and defines eight arcuate apertures 266 for filtering fluid passing therethrough and four mounting holes 268. The outer spacer disc includes a body portion 269 located radially outward of the filtration apertures 260 and 266 defined by the upper and the lower filter discs 252 and 256. As shown in FIG. 7, by disposing the outer spacer disc 254 between the upper and lower filter discs 252 and 256, a post-filtration gap or recess 282 is formed therebetween. The post-filtration gap 282 allows the filtration apertures 260 and 266 of the upper and lower filter discs 252 and 256 to be in fluid communication with the central core 272.

With continuing reference to FIG. 6, the inner spacer disc 270 includes a body portion 278 which is positioned radially inward of the filtration apertures 260 and 266 of the upper and lower filter discs 252 and 256. The positioning of the inner spacer disc 270 between adjacent filter disc assemblies 250 defines a pre-filtration gap 284 (FIG. 7) which allows fluid to be communicate between the inlet portion 222 (not shown) of the housing 210 and the filtration apertures 260 and 266.

Referring now to FIG. 7 which illustrates a partial cross sectional view of filter 200 and details the filtration flowpath within the interior cavity 232 of housing 210. Fluid which has been received into the interior cavity 232 through inlet portion 222 (not shown) travels initially along the outer periphery 233 of the interior cavity 232 over the path designated by flow arrow F. This fluid supplied to the filter 200 contains particles P which are suspended therein and are considered deleterious to the end use of the fluid and must be removed. Next, the fluid flows radially inward through the pre-filtration gap 284 established between adjacent filter disc assemblies 250. Particles P which are larger than the pre-filtration gap 284 are lodged along the edges of and between adjacent filter disc assemblies 250 and are thereby removed or filtered from the fluid. Then the pre-filter fluid passes through apertures 260 and 266 formed in the upper and lower filter discs 252 and 256 and is further conditioned thereby.

It should be noted that the apertures 260 and 266, in the embodiment shown herein, have a width smaller than that of the pre-filtration gap 284 and as a result, remove particles P which were able to pass through the pre-filtration gap 284 from the fluid. Unlike prior art edge-type filters, the fluid or filtrate is conditioned twice, first by gap filtration and then by aperture filtration. It should be noted that the size of the pre-filtration gap 260 can be adjusted by simply reducing the thickness of the inner spacer disc 235 and the aperture filtration can be adjusted by reducing or enlarging the size of the apertures 260 and 266.

As shown herein, apertures 260 and 266 have been cut in filter discs 252 and 256 parallel to the central axis 288 for filter 200. FIG. 7A illustrates an embodiment wherein the apertures 260a and 260b have been formed at an angle with respect to central axis 288. Providing the apertures 260a and 266a at an angle enhances the flow rate by providing a smoother transition from the pre-filtration gap 284 to the post-filtration gap 282.

Subsequent to the conditioning, the filtered fluid flows in a radially inward direction into the central core 272. The central core is in fluid communication with the outlet portion 226 (not shown) of the housing 210 and allows the filtered fluid to be discharged through outlet conduit 214 (not shown). Unlike the prior art edge-type filters, the flow path through the central core 272 is not obstructed by radial webs or mounting rods. The removal of these obstructions, increases the flow area, resulting in a higher achievable flow rate and lower differential pressure through this portion of the filter.

The filtration apertures 260 and 266 formed in the upper and lower filter discs 252 and 256 can be formed by mechanical cutting or preferably by laser cutting. In the embodiment shown herein, the apertures are formed by laser cutting. Laser cutting has several advantages over conventional mechanical cutting. Laser cutting results in a higher percentage of open area, provides apertures or slots which have a minimum relief, promotes the use of substantially harder metals or materials, and most importantly provides a method for accurately controlling the size of the and location of the apertures. Additionally, the use of a laser to cut the apertures permits the formation of complex hole or slot designs, such as arcuate, w-shaped or sinusoidal. A still yet further advantage is that the apertures may be formed true and substantially square at the respective surface interfaces or inclined with or against the direction of flow. The inclination of an opening or slot in alignment or parallel to the direction of the flow has the effect of enhancing the flow.

Filter discs used in prior art edge-type filters are fabricated by using conventional mechanical cutting techniques, such as stamping. The thickness of prior art discs is generally within the range of approximately 0.003″ to 0.015″. The stamping process by virtue of its physical shearing contact force applied to the thin sheet metal while forming the disc's webs and ring portions, distorts the flatness of the material. This process also limits the amount of metal that can be removed when creating the discs since the removal of too much material will weaken the remaining portions, causing tearing of the material. The use of laser cutting to fabricate the discs and the apertures reduces the amount deformation caused during fabrication since there is no physical contact between the laser and the plate. This process allows thinner plate stock to be used for all of the discs and more material to be removed. As noted above, by removing additional material from the central core 272, the available flow area can be dramatically increased.

The laser cutting process also allows for the aperture to be formed having a minimum relief. Unlike with mechanical cutting, laser cutting does not create large relief at the beginning and end of a slot.

The upper and lower filter discs are routinely manufactured from materials such as 304 stainless steel and brass. Since the laser cutting technique is relatively insensitive to the hardness of the material being cut, material such as extreme hardness steel alloys can be used for the plates and economically machined to reduce the rate of wear, thereby extending the life of the discs.

The use of a laser to fabricate the apertures formed in the filter discs allows for more accuracy in the control of their size compared to conventional mechanical cutting. With laser cutting, the filtration apertures that are defined by the upper and lower filter discs can be fabricated to have minimum width of approximately 0.0004 inch, controlled to a tolerance of plus 0.0005 inch. This is a dramatic reduction in the particle size that was previously achievable with prior art edge type filters, namely a particle size of 0.003 inch. Also, the accuracy in aperture gap size afforded by the laser allows for the filter to achieve an absolute rating.

The body portions of the upper and lower filter discs and the outer spacer disc can also be formed by laser cutting and their dimensions are controlled to a tolerance of approximately + or −0.002 inches. The use of a laser to form these features of the disc allows for the disc stack to be formed more precisely, resulting in the elimination of potential flow restriction that are created when the disc sizes differ even minutely.

As shown in FIGS. 8 through 10, the utilization of laser cutting to form the apertures allows for complex aperture designs to be employed. For example, FIG. 8 illustrates a pattern of eight arcuate apertures defined in upper filter disc 252. Alternatively, as shown in FIG. 9, the laser cutting technique provides a cost effective and arcuate method for forming multiple rows of apertures. Upper filter disc 352 has an outer row of eight arcuate apertures 360 and an inner row of sixteen arcuate apertures 362. A further example of the another possible aperture configuration which is afforded by laser cutting, is provided in FIG. 10. As shown therein, upper filter disc 460 has eight w-shaped apertures 460 formed therein. The ability to readily adjust the aperture size, quantity and arrangement enables the filter to be configured to suit a specific application and flow rate. Unlike prior art edge-type filters, the filter configuration disclosed herein provides multiple rows of apertures within a single filter disc, thereby increasing the available flow rate while maintaining an extremely small aperture size. Previously, the flow rate could only be increase by increasing the size of the filtration gaps, but this was done to the detriment of the filtration removal rating.

Referring now to FIG. 11 which illustrates a partial cross sectional view of an edge-type filter constructed in accordance with a preferred embodiment of the subject invention and designated generally by reference numeral 300. Filter 300 is similar in structure and function to the previously disclosed embodiments and like reference numerals refer to similar structural elements. Like filter 200, filter 300 is configured to provide a pre-filtration gap 384 and a post-filtration gap 382. However, unlike filter 200, the filter assembly 350 used in filter 300 includes upper and lower filter discs 352 (see FIG. 9 for detail) and 356 which have two rows of apertures which are circumferentially spaced apart. The additional row of apertures further increases the flow area and consequently the potential flow rate for the filter.

In edge-type filtration, as fluid passes through each aperture or gap there is an associated pressure drop that occurs. Therefore, the total pressure drop that occurs is found by summing the pressure drops encountered along the flow path as a result of each of the gaps, apertures or flow path restrictions. Therefore, by increasing the filtration area of a given filtration disc as well as by removing flow path restrictions for the filtration discs and subsequent filtration core, the configuration and method disclosed herein is able to provide a filter which has a greater flow potential as well as a lower differential pressure drop.

While the invention has been described with respect to preferred embodiments, those skilled in the art will readily appreciate that various changes and/or modifications can be made to the invention without departing from the spirit or scope of the invention as defined by the appended claims.

What is claimed is:

1. An edge-type filter cartridge comprising:
a) a housing having an inlet portion, an outlet portion, and defining a central axis and an interior cavity; and
b) a filter disc assembly coaxially stacked within the interior cavity of the housing for conditioning fluid passing therethrough, the filter disc assembly having a central core in fluid communication with the outlet portion of the housing and including:
i) an upper filter disc having a body portion and defining at least one filtration aperture for filtering fluid passing therethrough;
ii) a lower filter disc having a body portion and defining at least one filtration aperture for filtering fluid passing therethrough, the filtration apertures of the upper and lower discs being axially aligned; and
iii) an outer spacer disc including a body portion located radially outward of the filtration apertures defined by the upper and the lower filter discs, the outer spacer disc disposed between the upper and lower filter discs and defining a gap therebetween, the gap allowing the filtration apertures of the upper and lower filter discs to be in fluid communication with the central core of the filter disc assembly.

2. The filter cartridge as recited in claim 1, further comprising an upper inner spacer disc and a lower inner spacer disc, the upper inner spacer disc positioned adjacent to the upper filter disc and the lower inner spacer disc being positioned adjacent to the lower filter disc, each inner spacer disc includes a body portion being positioned radially inward of the at least one filtration aperture of the upper and lower filter discs and allowing fluid to communicate between the inlet portion of the housing and the filtration apertures of the upper and lower filter disc.

3. The filter cartridge as recited in claim 1, further comprising a mounting element extending through the interior cavity of the housing and parallel to the central axis for engaging the body portions of the upper and lower filter discs so as to secure the filter disc assembly within the interior cavity of the housing and maintain alignment of the filtration apertures.

4. The filter cartridge as recited in claim 3, wherein the mounting element comprises at least one elongated rod extending through the interior cavity of the housing and along the central axis for engaging the body portions of the upper and lower filter discs so as to secure the filter disc assembly within the interior cavity of the housing and maintain alignment of the filtration apertures.

5. The filter cartridge as recited in claim 3, wherein the mounting element comprises at least two diametrically opposed elongated rods which extend through the interior cavity of the housing parallel to the central axis and engage the body portions of the upper and lower filter discs.

6. The filter cartridge as recited in claim 1, wherein the at least one filtration aperture defined in each of the upper and lower filter discs is formed by laser cutting.

7. The filter cartridge as recited in claim 6, wherein the at least one filtration aperture defined in each of the upper and lower filter discs has a minimum width of 0.0004 inches.

8. The filter cartridge as recited in claim 6, wherein the at least one filtration aperture defined in each of the upper and lower filter discs has a width controlled to a tolerance of approximately plus 0.0005 inch.

9. The filter cartridge as recited in claim 1, wherein the body portions of the upper and lower filter discs and the outer spacer disc are formed by laser cutting.

10. The filter cartridge as recited in claim 9, wherein the body portions of the upper and lower filter discs are fabricated to a tolerance of approximately + or −0.001 inches.

11. The filter cartridge as recited in claim 1, wherein the at least one aperture defined in each of the upper and lower filter discs is linear.

12. The filter cartridge of claim 1, wherein the at least one aperture defined in each of the upper and lower filter discs is arcuate-shaped.

13. The filter cartridge of claim 1, wherein the at least one aperture defined in each of the upper and lower filter discs is w-shaped.

14. The filter cartridge of claim 1, wherein the at least one aperture defined in each of the upper and lower filter discs is sinusoidal.

15. The filter cartridge of claim 1, wherein the at least one aperture defined in each of the upper and lower filter discs comprises multiple rows of apertures.

16. The filter cartridge as recited in claim 1, wherein the upper and lower filter discs are formed from material selected from the group consisting of steel, 304 stainless steel, 316 stainless steel and brass.

17. The filter cartridge as recited in claim 1, wherein the at least one aperture defined in each of the upper and lower filter discs is formed parallel to the central axis.

18. The filter cartridge as recited in claim 1, wherein the at least one aperture defined in each of the upper and lower filter discs is formed at an angle relative to the central axis.

19. An edge-type filter cartridge comprising:
a) a housing having an inlet portion, an outlet portion, and defining a central axis and an interior cavity;
b) a plurality of filter disc assemblies coaxially stacked within the interior cavity of the housing for conditioning fluid passing therethrough, the plurality of filter disc assemblies having a central core in fluid communication with the outlet portion of the housing and including:
i) an upper filter disc having a body portion and defining at least one filtration aperture for filtering fluid passing therethrough;
ii) a lower filter disc having a body portion and defining at least one filtration aperture for filtering fluid passing therethrough; and
iii) an outer spacer disc including a body portion located radially outward of the filtration apertures defined by the upper and the lower filter discs, the outer spacer disc disposed between the upper and lower filter discs and defining a gap therebetween, the gap allowing the filtration apertures of the upper and lower filter discs to be in fluid communication with the central core of the filter disc assembly; and
c) an inner spacer disc positioned between adjacent filter disc assemblies, the inner spacer disc including a body portion being positioned radially inward of the filtration apertures of the upper and lower filter discs and defining a pre-filtration gap between filter disc assemblies which is in fluid communication with the inlet portion of the housing.

20. The filter cartridge as recited in claim 19, further comprising a mounting element extending through the interior cavity of the housing and parallel to the central axis for engaging the mounting portions of the upper and lower filter discs and the inner spacer disc so as to secure the plurality of filter disc assemblies and the inner spacer discs within the interior cavity of the housing and maintain alignment of the filtration apertures.

21. The filter cartridge as recited in claim 20, wherein the mounting element comprises at least two diametrically opposed elongated rods which extend through the interior cavity of the housing parallel to the central axis and engage the body portions of the upper and lower filter discs.

22. The filter cartridge as recited in claim 19, wherein the at least one filtration aperture defined in each of the upper and lower filter discs is formed by laser cutting.

23. The filter cartridge as recited in claim 22, wherein the at least one filtration aperture defined in the upper and lower filter discs have a minimum width of 0.0004 inches.

24. The filter cartridge as recited in claim 23, wherein the at least one filtration aperture defined in the upper and lower filter discs has a width controlled to a tolerance of approximately plus 0.0005 inch.

25. The filter cartridge as recited in claim 21, wherein the body portions of the upper and lower filter discs and the outer spacer disc are formed by laser cutting.

26. The filter cartridge as recited in claim 25, wherein the body portions of the upper and lower filter discs and the outer spacer disc are fabricated to a tolerance of approximately + or −0.002 inches.

27. The filter cartridge as recited in claim 19, wherein the at least one aperture defined in each of the upper and lower filter discs is linear.

28. The filter cartridge of claim 19, wherein the at least one aperture defined in each of the upper and lower filter discs is arcuate-shaped.

29. The filter cartridge of claim 19, wherein the at least one aperture defined in each of the upper and lower filter discs is w-shaped.

30. The filter cartridge of claim 19, wherein the at least one aperture defined in each of the upper and lower filter discs is sinusoidal.

31. The filter cartridge of claim 19, wherein the at least one aperture defined in each of the upper and lower filter discs comprises multiple rows apertures.

32. The filter cartridge as recited in claim 19, wherein the upper and lower filter discs are formed from material selected from the group consisting of steel, 304 stainless steel and brass.

33. The filter cartridge as recited in claim 19, wherein the at least one aperture defined in each of the upper and lower filter discs is formed parallel to the central axis.

34. The filter cartridge as recited in claim 19, wherein the at least one aperture defined in each of the upper and lower filter discs is formed at an angle relative to the central axis.

35. A filter disc for use in an edge-type filter comprising:
a) a ring portion having opposed upper and lower faces; and
b) at least one filtration aperture formed in the ring portion by laser cutting and extending between the upper and lower faces for filtering fluid passing therethrough.

36. The filter disc of claim 35, further comprising a mounting portion associated with the ring portion for securing the filter disc within a filter cartridge.

37. The filter disc as recited in claim 35, wherein the at least one laser cut filtration aperture defined in the ring portion has a width controlled to a tolerance of approximately plus 0.0005 inch.

38. The filter disc as recited in claim 35, wherein the ring portion of the filter disc is formed by laser cutting.

39. The filter cartridge as recited in claim 38, wherein the laser cut ring portion of the filter disc is fabricated to a tolerance of approximately plus 0.001 inches.

40. The filter disc as recited in claim 35, wherein the at least one aperture is linear.

41. The filter disc as recited in claim 35, wherein the at least one aperture is arcuate-shaped.

42. The filter disc as recited in claim 35, wherein the at least one aperture is w-shaped.

43. The filter disc as recited in claim 35, wherein the at least one aperture is sinusoidal.

44. The filter disc as recited in claim 35, wherein the at least one aperture comprises multiple rows of apertures.

45. The filter disc as recited in claim 35, wherein the filter disc is manufactured from material selected from the group consisting of steel, 304 stainless steel, 316 stainless steel and brass.

46. The filter cartridge as recited in claim 35, wherein the at least one aperture defined in each of the upper and lower filter discs is formed parallel to the central axis.

47. The filter cartridge as recited in claim 35, wherein the at least one aperture defined in each of the upper and lower filter discs is formed at an angle with respect to the central axis.

48. A method of making a filter disc for use in an edge-type filter, comprising the steps of:
a) providing a stock piece of steel sheet having a selected thickness;
b) cutting a circular filter disc from the steel sheet using a laser so as to define a ring portion having at least one filtration aperture formed therein.

49. The method as recited in claim 49, further comprising the step of laser cutting the at least one aperture defined in the ring portion of the circular filter disc.

50. The method as recited in claim 49, further comprising the step of:
flattening the filter disc by mechanical rolling.
